(19) United States
(12) Patent Application Publication
(10) Pub. No.: US 2018/0217774 A1
(43) Pub. Date: Aug. 2, 2018

(54) VIRTUAL MEMORY MANAGEMENT APPARATUS FOR AVOIDING ERROR CELL IN MAIN MEMORY AND METHOD THEREFOR

(71) Applicant: Korea University Research and Business Foundation, Seoul (KR)

(72) Inventors: Seon Wook KIM, Namyangju-si (KR); Yoonah PAIK, Seoul (KR); Jae Yung JUN, Seoul (KR)

(73) Assignee: Korea University Research and Business Foundation, Seoul (KR)

(21) Appl. No.: 15/748,003

(22) PCT Filed: Apr. 7, 2017
(86) PCT No.: PCT/KR2017/003813

§ 371 Date: Jan. 26, 2018

(30) Foreign Application Priority Data
Apr. 29, 2016 (KR) 10-2016-0053383

(51) Int. Cl. G06F 3/06

(52) U.S. Cl. CPC G06F 3/0631; G06F 3/0673; G06F 3/0619; G06F 3/0604

(57) ABSTRACT

Disclosed are a virtual memory management apparatus for avoiding error cells in a main memory and a method thereof. That is, according to the present invention, it is possible to prevent a data loss or malfunction from occurring by allocating and releasing a stack frame in a way a block including the error cells to be located between the stack frames in case of a stack region, processing the block including the error cells to be in an allocated state in a heap region memory management data structure in case of a heap region, allocating the pages including error cells to programs not used frequently via profile in case of code memory, and allocating physical memory page including the error cells to unused space of last page in case of file-mapped memory.

### TECHNICAL FIELD

The present invention relates to a virtual memory management apparatus for avoiding error cells in a main memory and a method thereof, which uses characteristics of virtual memories as follows. In case of a stack region, stack frames are allocated and freed in a way that blocks including error cells are located between stack frames. In case of a heap region, blocks including error cells are marked to be in an allocated state in data structure for heap management. In case of code memory, the pages including error cells are allocated to parts of code not used frequently via profile. In case of file-mapped memory, physical memory page including the error cells is allocated to unused space of last page.

### BACKGROUND ART

When errors occur in a memory, values written in a program are not stored as it is and a data loss may occur and the program may malfunction since the written values are read as different values due to the errors.

To solve this problem, a method of detecting/correcting or avoiding errors in the memory in hardware or software has been used.

That is, as the hardware method, a space having the errors is replaced with an extra space by using an extra memory space or codes (for example, an error correction code) capable of detecting or correcting the errors are stored in the extra memory space to detect or correct the errors, thereby preventing data loss and malfunction, but in the hardware method, since the extra memory space is required, the costs thereof increase.

Further, as the software method, in a memory management system of an operating system, an access to the error cells may be avoided by a method in which a memory space (alternatively, a page) with the errors is not allocated in the program, but since the memory management of the operating system is performed by a page unit, the entire page can not be used even if there is only one error included in the page.

### PRIOR ART DOCUMENT

### Patent Document

Korean Patent Laid-Open Publication No. 10-2007-0098133 [Title of invention: Error block management method of flash memory]

### DISCLOSURE

### Technical Problem

An object of the present invention is to provide a virtual memory management apparatus for avoiding error cells in a main memory and a method thereof to prevent software from accessing a memory region with errors.

Another object of the present invention is to provide a virtual memory management apparatus for avoiding error cells in a main memory and a method thereof in which stack frames are allocated and freed in a way that blocks including error cells are located between stack frames in case of a stack region, blocks including error cells are marked to be in an allocated state in data structure for heap management in case of a heap region, the pages including error cells are allocated to parts of code memory not used frequently via profile in case of code memory, and physical memory page including the error cells is allocated to unused space of last page in case of file-mapped memory.

### Technical Solution

According to an aspect of the present invention, there is provided a stack memory management method for avoiding error cells in a main memory including: checking, by a memory management unit, information on error cells in the main memory; checking, by the memory management unit, whether the error cells are located in a space to be allocated to a stack frame of a callee when allocating the stack frame; and configuring, by the memory management unit, the error cells to be located between a stack frame of a caller and the stack frame of the callee by adjusting a location of the stack frame of the callee to be next to a block including the error cells, when the error cells are located in the space to be allocated to the stack frame of the callee, as the checking result.

As an example related with the present invention, in the configuring of the error cells to be located between the stack frame of the caller and the stack frame of the callee, the memory management unit may allocate the stack frame of the callee by reducing a stack pointer corresponding to the last point of the stack frame of the caller by a size corresponding to the space including the error cells and a size corresponding to the stack frame of the callee.

As an example related with the present invention, the stack memory management method may further include allocating, by the memory management unit, the stack frame of the callee by reducing the stack pointer corresponding to the last point of the stack frame of the caller by a size corresponding to the stack frame of the callee, when the error cells are not located in the space to be allocated to the stack frame of the callee, as the checking result.

As an example related with the present invention, the stack memory management method may further include moving, by the memory management unit, a stack pointer located at the last point of the stack frame of the callee to an end point of the stack frame of the caller calling the callee when the stack frame allocated to the callee is released.

According to another aspect of the present invention, there is provided a heap memory management method for avoiding error cells in a main memory including: checking, by a memory management unit, information on error cells in the main memory; determining, by the memory management unit, whether a chunk including error cells is present in a plurality of chunks included in a free chunk list; configuring, by the memory management unit, a block including the error cells in the free chunk list to an allocated state, when the chunk including the error cells is present in the plurality of chunks included in the free chunk list, as the determining result; generating, by the memory management unit, a new free chunk list by deleting the block including the error cells in the free chunk list after the block including the error cells is marked to be the allocated state; and allocating, by the memory management unit, a free chunk to a program based on the new free chunk list.

As an example related with the present invention, the free chunk list may include information on a memory space available for dynamic memory allocation in a heap memory region.

As an example related with the present invention, the heap memory management method may further include switching, by the memory management unit, the allocated chunk to a free state by registering the chunk in the new free chunk list, when the chunk is freed.

According to yet another aspect of the present invention, there is provided a stack memory management apparatus for avoiding error cells in a main memory including a main memory; and a memory management unit configured to check information on error cells in the main memory, and configure the error cells to be located between a stack frame of a caller and a stack frame of a callee by adjusting a location of the stack frame of the callee to be next to a space including the error cells, when the error cells are located in the space to be allocated to the stack frame of the callee when allocating the stack frame.

As an example related with the present invention, the memory management unit may move a stack pointer located at the last point of the stack frame of the callee to an end point of the stack frame of the caller calling the callee, when the stack frame allocated to the callee is released.

According to still another aspect of the present invention, there is provided a heap memory management apparatus for avoiding error cells in a main memory including: a main memory; and a memory management unit configured to check information on error cells in the main memory, configure a block including the error cells in a free chunk list to an allocated state, when a chunk including the error cells is present in a plurality of chunks included in the free chunk list, generate a new free chunk list by deleting the block including the error cells from the free chunk list after the block including the error cells is marked to be the allocated state, and allocate a free chunk to program based on the new free chunk list.

As an example related with the present invention, the memory management unit may switch the allocated chunk to a free state by registering the chunk in the new free chunk list, when the chunk is freed.

According to still another aspect of the present invention, there is provided a code memory management method for avoiding error cells in a main memory, including: checking, by a memory management unit, information on error cells in the main memory; re-arranging, by the memory management unit, codes according to number of use of each of the codes based on profile result; allocating, by the memory management unit, one or more pages including the error cells to one or more of the codes not frequently used; and re-allocating, when accessing the codes mapped to the error cells, by the memory management unit, the one or more of the codes not frequently used to one or more pages including the error cells and re-reading the code from a storage.

According to still another aspect of the present invention, there is provided a file-mapped memory management method for avoiding error cells in a main memory, including: checking, by a memory management unit, information on error cells in the main memory; checking, by the memory management unit, unused space during rounding off size of file-mapped memory by a unit of page; and allocating, by the memory management unit, a physical memory page including the error cells to the unused space.

### Advantageous Effects

According to the present invention, it is possible to prevent a data loss or malfunction which may occur when the processor uses error cells in the main memory by preventing the software from accessing a memory region with the errors.

Further, it is possible to maximize a memory capacity which is allocable to the program and reduce the costs by not using an additional memory as compared with a conventional software solution method by allocating and releasing a stack frame in a way a block including the error cells to be located between the stack frames in case of a stack region, processing the block including the error cells to be in an allocated state in a heap region memory management data structure in case of a heap region, allocating the pages including error cells to programs not used frequently via profile in case of code memory, and allocating physical memory page including the error cells to unused space of last page in case of file-mapped memory.

### BRIEF DESCRIPTION OF DRAWINGS

FIG. 1 is a block diagram illustrating a configuration of a stack and heap memory management apparatus for avoiding error cells in a main memory according to an embodiment of the present invention.

FIG. 2 is a memory configuration diagram illustrating the case where a stack frame is allocated in a system in which technical features of the present invention are not considered.

FIG. 3 is a memory configuration diagram illustrating the case where a stack frame is allocated according to an embodiment of the present invention.

FIG. 4 is a code configuration diagram illustrating a case where a stack frame is allocated and released in a system in which technical features of the present invention are not considered.

FIG. 5 is a code configuration diagram illustrating a case where a stack frame is allocated and released according to an embodiment of the present invention.

FIG. 6 is a flowchart illustrating a stack memory management method for avoiding error cells in a main memory according to a first embodiment of the present invention.

FIGS. 7 to 9 are diagrams illustrating the stack memory management for avoiding the error cells in the main memory according to the first embodiment of the present invention.

FIG. 10 is a flowchart illustrating a heap memory management method for avoiding error cells in a main memory according to a second embodiment of the present invention.

FIGS. 11 to 14 are diagrams illustrating the heap memory management for avoiding the error cells in the main memory according to the second embodiment of the present invention.

FIG. 15 is a diagram illustrating a code memory management for avoiding the error cells in the main memory according to the present invention.

FIG. 16 is a diagram illustrating a file-mapped memory management for avoiding the error cells in the main memory according to the present invention.

### MODES OF THE INVENTION

Technical terms used in the present invention are used only to describe specific embodiments, and are not intended to limit the present invention. Further, unless otherwise defined, the technical terms used in the present invention should be interpreted as meanings generally appreciated by those skilled in the art and should not be interpreted as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

Further, singular expressions used in the present invention include plural expressions unless they have definitely opposite meanings in the context. In the present invention, a term such as “comprising” or “including” should not be interpreted as necessarily including all various components or various steps disclosed in the invention, and it should be interpreted that some component or some steps among them may not be included or additional components or steps may be further included.

Further, terms including an ordinary number, such as first and second, and the like are used for describing various components, but the components are not limited by the terms. The above terms are used only to discriminate one component from the other components. For example, a first component may be referred to as a second component, and similarly, the second component may be referred to as the first component without departing from the scope of the present invention.

Hereinafter, the present invention will be described in detail with reference to the accompanying drawings, in which like reference numerals refer to like or similar elements regardless of reference numerals and a duplicated description thereof will be omitted.

In describing the present invention, when it is determined that the detailed description of the publicly known art related to the present invention may obscure the gist of the present invention, the detailed description thereof will be omitted. Further, it is noted that the accompanying drawings are only for easily understanding the spirit of the present invention and it should not be interpreted that the spirit of the present invention is limited by the accompanying drawings.

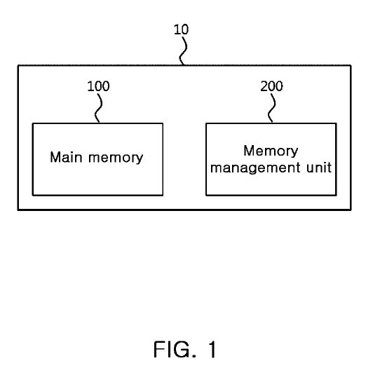

FIG. 1 is a block diagram illustrating a configuration of a stack and heap memory management apparatus 10 for avoiding error cells in a main memory according to an embodiment of the present invention.

As illustrated in FIG. 1, a stack and heap memory management apparatus 10 includes a main memory 100 and a memory management unit 200. All the components of the stack and heap memory management apparatus 10 illustrated in FIG. 1 are not necessary components, and the stack and heap memory management apparatus 10 may be implemented by more components or less components than the components illustrated in FIG. 1.

The main memory 100 allocates a memory region to be used in an arbitrary program to a stack memory, a heap memory, file-mapped memory and the like, by the control of the operating system (alternatively, the memory management unit 200).

The memory management unit 200 (alternatively, a central processing unit (CPU)) performs an overall control function of the memory management apparatus 10.

Further, the memory management unit 200 checks information on error cells in the main memory 100.

In addition, when a called function (callee) is called in any call function (caller) of the program and a stack frame in the main memory 100 needs to be allocated for the callee, the memory management unit 200 checks (alternatively, determines) whether or not error cells are located (alternatively, present) in a space where the stack frame for the corresponding callee is to be allocated in the main memory 100.

That is, when it is necessary to allocate the stack frame in the main memory 100 for the callee by calling the callee in any caller of the program, the memory management unit 200 checks whether the error cells included in the space where the stack frame of the callee is to be allocated based on the known information of the checked error cells.

As the checking result (alternatively, the determined result), when the error cells are not located (alternatively, present) in the space to where the stack frame of the corresponding callee is to be allocated, the memory management unit 200 reduces a stack pointer corresponding to the stack frame of the caller (alternatively, a stack pointer corresponding to the last point of the stack frame of the caller) by a size corresponding to the space to allocate the stack frame of the callee to allocate the corresponding stack frame of the callee.

That is, when the error cells are not included in the space where the stack frame of the callee is to be allocated based on the known information of the checked error cells, the memory management unit 200 reduces a stack pointer corresponding to the stack frame of the caller (alternatively, a stack pointer corresponding to the last point of the stack frame of the caller) by a size corresponding to the space to allocate the stack frame of the callee to allocate the corresponding stack frame of the callee.

Further, as the checking result (alternatively, the determined result), when the error cells are located (alternatively, present) in the space where the stack frame of the corresponding callee is to be allocated, the memory management unit 200 controls the location of the stack frame of the callee to be located next to the block including the corresponding error cells so that the error cells (alternatively, the block including the error cells) are located (alternatively, present) between the stack frame of the caller and the stack frame of the callee.

That is, when the error cells are located (alternatively, present) in the space where the stack frame of the corresponding callee is to be allocated, the memory management unit 200 reduces the stack pointer corresponding to the last point of the stack frame of the caller by the size corresponding to total size of the block including the error cell and the size corresponding to the stack frame of the callee to allocate the corresponding stack frame of the callee.

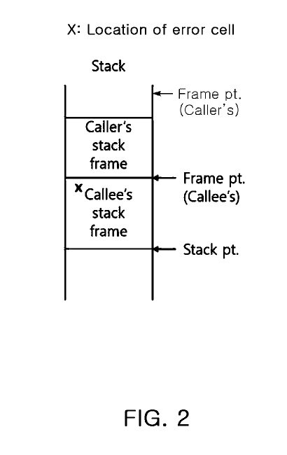

As illustrated in FIG. 2, when the stack frame is allocated in a system in which the technical features of the present invention are not considered, the stack frames of the caller and the callee are consecutively located, and the error cells may be located in the stack frame of the callee. In this case, a data stored in the error cells may be lost and a malfunction of the program can be caused.

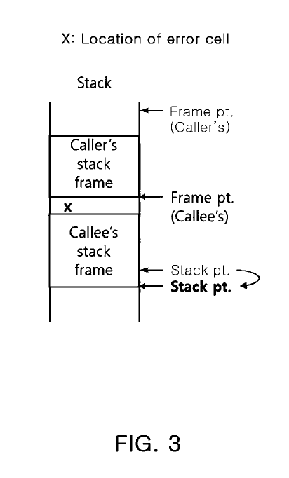

As illustrated in FIG. 3, when the stack frame is allocated in a system in which the technical features of the present invention are considered, the error cells are located between the stack frames of the caller and the callee. In this case, the error cells are not accessed and the loss of the data or the malfunction of the program can be avoided.

In addition, when the stack frame allocated to the callee is released (free), the memory management unit 200 moves the stack pointer located at the last point of the stack frame of the callee to an end point of the stack frame of the caller calling the callee in a current state.

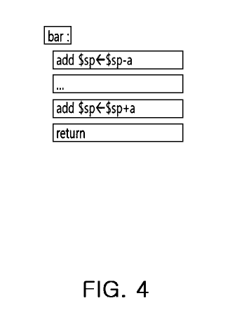

As illustrated in FIG. 4, in the case of code generation of a compiler at the time of allocating and releasing the stack frame in the system in which the technical features of the present invention are not considered, when allocating the stack frame for the callee, the compiler (alternatively, the memory management unit 200) moves the stack pointer by a space (for example, a) to allocate the stack frame for the callee. Further, when releasing the stack frame for the callee, the compiler (alternatively, the memory management unit 200) lifts (alternatively, moves) the stack pointer by the space (for example, a) corresponding to the stack frame for the callee at the time of releasing the stack frame.

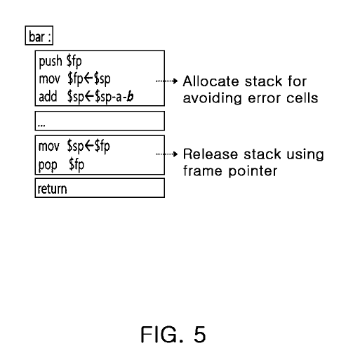

As illustrated in FIG. 5, in the case of code generation of a compiler at the time of allocating and releasing the stack frame in the system in which the technical features of the present invention are considered, the compiler (alternatively, the memory management unit 200) moves the stack pointer by the total size of the space (for example, a) corresponding to the size of the stack frame to be allocated and the space (for example, b) corresponding to the block including the error cells to allocate the stack frame. Further, the compiler (alternatively, the memory management unit 200) changes the stack pointer to the location of the frame pointer at the time of releasing the stack frame.

As described above, in the embodiment of the present invention, a physical memory region (alternatively, a page) including the error cells is allocated to the stack space in the operating system and the stack frame is controlled so that the block including the error cells is located between the stack frames in the stack region to avoid the error cells of the main memory 100.

In the embodiment of the present invention, it is described that the stack point value is reduced in the memory management unit 200 to allocate the space to be stored in the stack memory, but the present invention is not limited thereto and the management method of the stack memory may vary depending on the processor (alternatively, the memory management unit 200).

That is, when the caller calls the callee, the memory management unit 200 may also increase the stack pointer value to allocate the space of the stack frame.

Further, when a frame pointer register is not defined, the memory management unit 200 may alternatively use a general register as the frame pointer.

Further, an error avoiding method according to the embodiment of the present invention uses the step of allocating or releasing the heap memory in the memory management in an existing heap region without changing the step.

Here, the heap region represents a memory space to be used for dynamic memory allocation. The heap space is managed by a system library, and the program may request to allocate (for example, malloc)/release (for example, free) the memory through a function provided by the library. The library manages the allocated memory space as a list of a chunk unit which is an internal data structure.

In addition, the memory management unit 200 determines (alternatively, checks) whether the chunk including the error cells exists in a plurality of (alternatively, one or more) chunks included in a free chunk list. Here, the free chunk list includes information on a memory space available for dynamic memory allocation in the heap memory region. Further, the memory chunk list includes the memory space available for dynamic memory allocation in the heap memory region and the memory space allocated to the program.

That is, the memory management unit 200 determines whether a chunk including the known error cells exists in the plurality of chunks included in the free chunk list. Here, the free chunk list is the information on the available memory space to be allocated as the dynamic memory in the heap memory region.

As the determining result (alternatively, the checked result), when the chunk including the error cells does not exist in the plurality of chunks included in the free chunk list, the memory management unit 200 allocates a heap memory to any request (for example, a malloc function) of the program based on the free chunk list.

Further, as the determining result (alternatively, the checked result), when the chunk including the error cells exists in the plurality of chunks included in the free chunk list, the memory management unit 200 configures the corresponding block (alternatively, the corresponding chunk) including the error cells included in the free chunk list to an allocated state.

In addition, the memory management unit 200 deletes (alternatively, excludes) the corresponding block (alternatively, the chunk) including the error cells from the free chunk list according to the configuration of the allocated state of the block including the error cells to generate a new free chunk list (alternatively, updates the free chunk list by removing the chunk including the error cells).

As such, the memory allocation in the heap region is performed by returning the chunk registered in the free chunk list to the program. Further, since the chunk represented in the allocated state is excluded from the free chunk list, the chunk is never allocated unless registered in the free chunk list again.

Further, the memory management unit 200 allocates a heap memory to any request (for example, the malloc function) of the program based on the new free chunk list (alternatively, the free chunk list in which the block including the error cells is deleted).

Further, in the case of releasing the heap memory allocated to the request, the memory management unit 200 registers the chunk corresponding to the heap memory allocated to the request in the latest free chunk list (alternatively, the new free chunk list) to switch the heap memory allocated to the caller to an available state.

As described above, in the embodiment of the present invention, in the operating system, the physical memory region (alternatively, the page) including the error cells is allocated to the heap space, and in the heap area, the block including the error cells is represented in the allocated state in the heap region memory management data structure (the chunk list). As a result, the access to the error cells does not occur and thus the loss of the data and the malfunction of the program are not generated, thereby avoiding the error cells of the main memory 100.

In the embodiment of the present invention, it is described that the stack memory management and the heap memory management are performed to avoid the error cells of the main memory, respectively, but the present invention is not limited thereto. In addition, the memory management unit 200 checks whether any memory allocation of the stack memory allocation and the heap memory allocation is required and may also perform any one function of the stack memory allocation function and the heap memory allocation function according to the checked result, with respect to the program which is currently to be executed or being executed.

That is, the memory management unit 200 checks (alternatively, distinguishes) any one of the stack frame allocation and the heap frame allocation according to the execution of the program, and may allocate the stack frame according to the above described stack frame allocation method or allocate the heap frame according to the above described heap frame allocation method based on the checking result (alternatively, the distinguished result).

As such, it is possible to prevent the software from accessing the memory region in which the error occurs.

Also, as such, in the case of the stack region, the stack frame is allocated and released so that the block including the error cells is located between the stack frames, and in the case of the heap region, the block including the error cells is marked to be allocated state.

Hereinafter, a stack and heap memory management method for avoiding error cells in the main memory according to the present invention will be described in detail with reference to FIGS. 1 to 14.

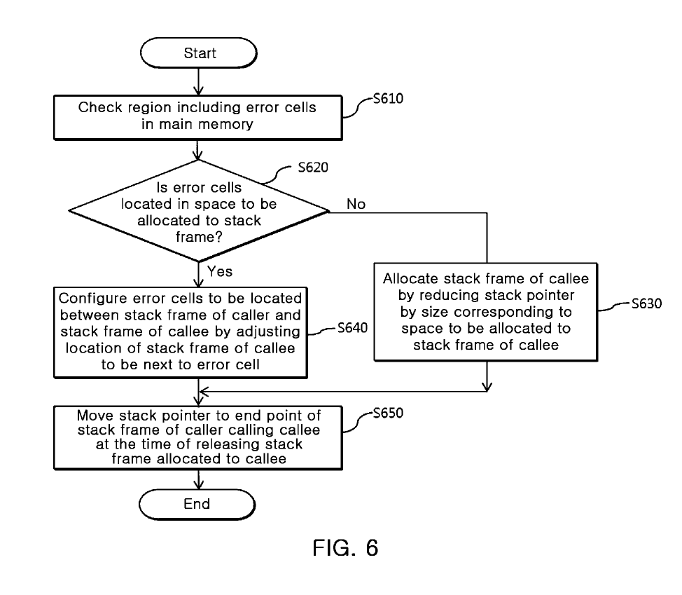

FIG. 6 is a flowchart illustrating a stack memory management method for avoiding error cells in a main memory according to a first embodiment of the present invention.

First, the memory management unit 200 checks information on error cells in the main memory 100.

As an example, the memory management unit 200 checks a region including the error cells in the main memory 100 (S610).

Thereafter, when a called function (callee) is called in any call function (caller) of the program and a stack frame in the main memory 100 for the callee needs to be allocated, the memory management unit 200 checks (alternatively, determines) whether the error cells are located (alternatively, present) in a space where the stack frame of the corresponding callee in the main memory 100 is to be allocated.

That is, when it is necessary to allocate the stack frame in the main memory 100 for the callee by calling the callee in any caller of the program, the memory management unit 200 checks whether the error cells are included in the space, where the stack frame of the callee is to be allocated, based on the checked region including error cells.

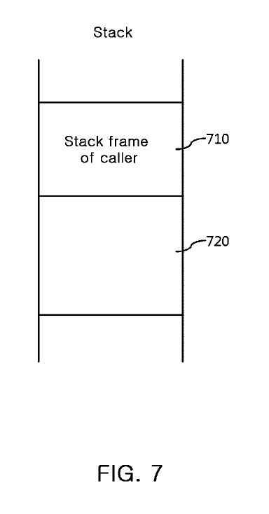

As an example, as illustrated in FIG. 7, when it is necessary to allocate a stack frame for the callee while a stack frame 710 of the caller is allocated in the main memory 100, the memory management unit 200 checks whether the error cells exist in a space 720 when allocating the stack frame of the callee (S620).

As the checking result (alternatively, the determined result), when the error cells are not located (alternatively, present) in the space where the stack frame of the corresponding callee is to be allocated, the memory management unit 200 reduces a stack pointer corresponding to the stack frame of the caller (alternatively, a stack pointer corresponding to the last point of the stack frame of the caller) by a size corresponding to the space to be allocated as the stack frame of the callee to allocate the corresponding stack frame of the callee.

That is, when the error cells are not included in the space where the stack frame of the callee is to be allocated based on the checked region including error cells, the memory management unit 200 reduces a stack pointer corresponding to the stack frame of the caller (alternatively, a stack pointer corresponding to the last point of the stack frame of the caller) by a size corresponding to the space to be allocated as the stack frame of the callee to allocate the corresponding stack frame of the callee.

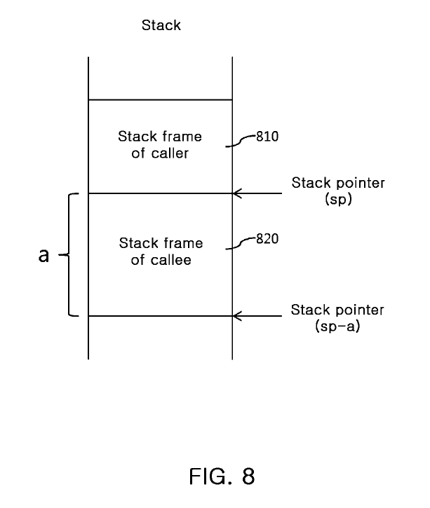

As an example, when the error cells are not present in the space 720 which is to be allocated as the stack frame of the callee illustrated in FIG. 7, as illustrated in FIG. 8, the memory management unit 200 allocates a stack frame 820 of the callee to a next region after a stack frame 810 of the caller. In this case, the memory management unit 200 reduces a stack pointer (for example, sp) corresponding to the last point (alternatively, the end point) of the stack frame 810 of the caller by a size (for example, a) corresponding to the space to be allocated as the stack frame of the callee (for example, sp-a) to allocate the corresponding stack frame 820 of the callee and configures a stack pointer (for example, sp-a) corresponding to the last point of the corresponding stack frame 820 of the callee (S630).

Further, as the checking result (alternatively, the determined result), when the error cells are located (alternatively, present) in the space to be allocated as the stack frame of the corresponding callee, the memory management unit 200 controls the location of the stack frame of the callee to be located next to the block including the corresponding error cells so that the error cells (alternatively, the block including the error cells) are located (alternatively, present) between the stack frame of the caller and the stack frame of the callee.

That is, when the error cells are located (alternatively, present) in the space to be allocated as the stack frame of the corresponding callee, the memory management unit 200 reduces the stack pointer corresponding to the last point of the stack frame of the caller by the size corresponding to the block including the error cell and the size corresponding to the space to be allocated as the stack frame of the callee to allocate the corresponding stack frame of the callee.

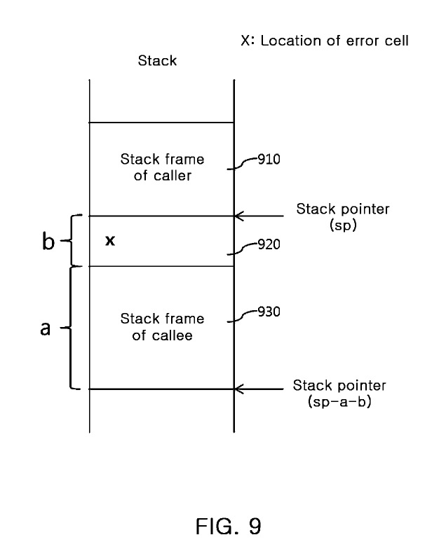

As an example, when the error cells are present in the space 720 to be allocated as the stack frame of the callee illustrated in FIG. 7, as illustrated in FIG. 9, the memory management unit 200 allocates a stack frame 930 of the callee to a next region of a block 920 including the error cells after a stack frame 910 of the caller. In this case, the memory management unit 200 reduces (for example, sp-a-b) the stack pointer (for example, sp) corresponding to the last point of the stack frame 910 of the caller by a size (for example, b) corresponding to the block including the error cells and the size (for example, a) corresponding to the space to be allocated as the stack frame of the callee to allocate the corresponding stack frame 930 of the callee and configures a stack pointer (for example, sp-a-b) corresponding to the last point of the corresponding stack frame 930 of the callee (S640).

Thereafter, when the stack frame allocated to the callee is released (free), the memory management unit 200 moves the stack pointer located at the last point of the stack frame of the callee in a current state to an end point of the stack frame of the caller calling the callee.

For example, when the stack frames 820 and 930 of the caller in FIGS. 8 and 9 are released, the memory management unit 200 moves the stack pointer (for example, sp-a in FIG. 8 and sp-a-b in FIG. 9) at the current location to the end point (for example, sp) of the stack frame of the caller calling the callee (S650).

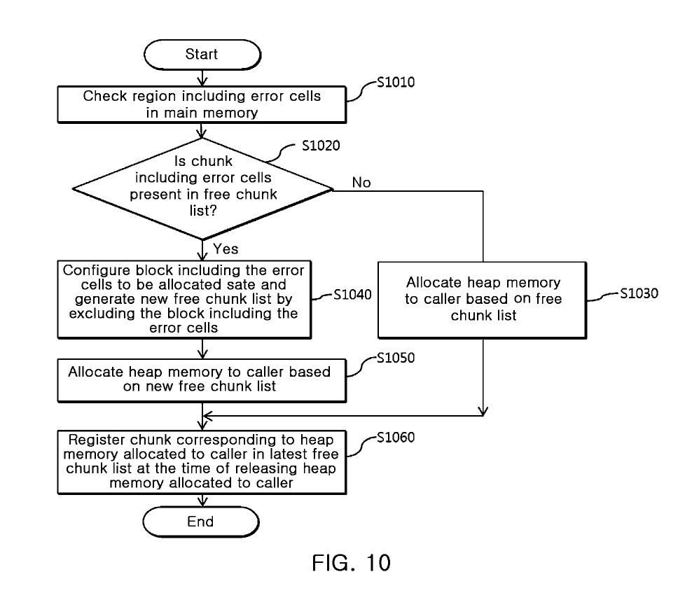

FIG. 10 is a flowchart illustrating a stack memory management method for avoiding error cells in a main memory according to a second embodiment of the present invention.

First, the memory management unit 200 checks information on error cells in the main memory 100.

As an example, the memory management unit 200 checks a region including the error cells in the main memory 100 (S1010).

Thereafter, the memory management unit 200 determines (alternatively, checks) whether a chunk including the error cells exists in a plurality of (alternatively, one or more) chunks included in a free chunk list. Here, the free chunk list includes information on a memory space available for dynamic memory allocation in the heap memory region. Further, the memory chunk list includes the memory space available for dynamic memory allocation in the heap memory region and the memory space allocated to the program.

That is, the memory management unit 200 determines whether the checked chunk including the error cells is present in the plurality of chunks included in the free chunk list, which is the information on the available memory space to allocate the dynamic memory in the heap memory region.

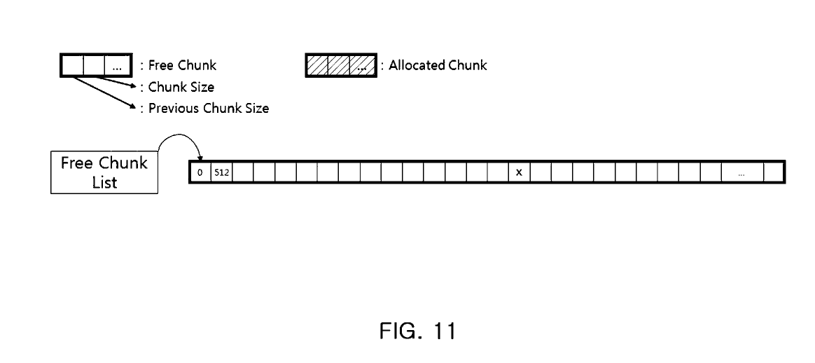

As an example, as illustrated in FIG. 11, the memory management unit 200 determines whether the chunk including the error cells is present in the free chunk list included in the memory chunk list. Here, the number of the first column of the chunk (alternatively, the block) represents a size (byte) of the previous chunk, and the number of the second column of the chunk represents the size of the corresponding chunk (S1020).

As the determining result (alternatively, the checked result), when the chunk including the error cells is not present in the plurality of chunks included in the free chunk list, the memory management unit 200 allocates a heap memory to any caller (for example, a malloc function) of the program based on the free chunk list.

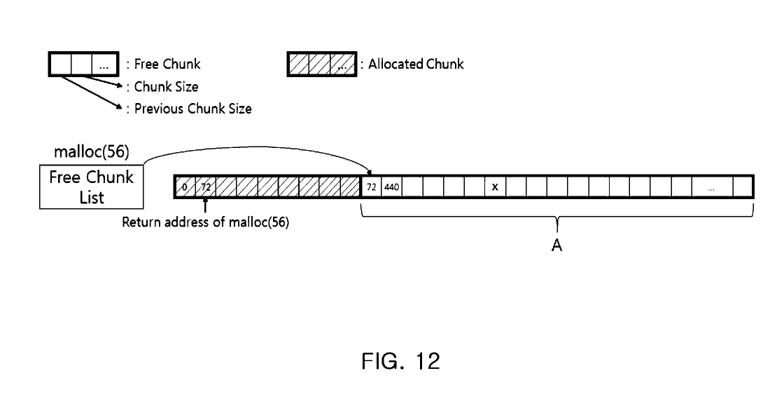

As an example, when the chunk including the error cells is not present in the free chunk list included in the memory chunk list, as illustrated in FIG. 12, the memory management unit 200 allocates a heap memory (for example, a block A) to the malloc function based on the free chunk list (S1030).

Further, as the determining result (alternatively, the checked result), when the chunk including the error cells is present in the plurality of chunks included in the free chunk list, the memory management unit 200 configures the corresponding block (alternatively, the corresponding chunk) including the error cells included in the free chunk list to an allocated state.

In addition, the memory management unit 200 deletes (alternatively, excludes) the corresponding block (alternatively, the corresponding chunk) including the error cells from the free chunk list according to the configuration of the allocated state of the block including the error cells to generate a new free chunk list (alternatively, updates the free chunk list).

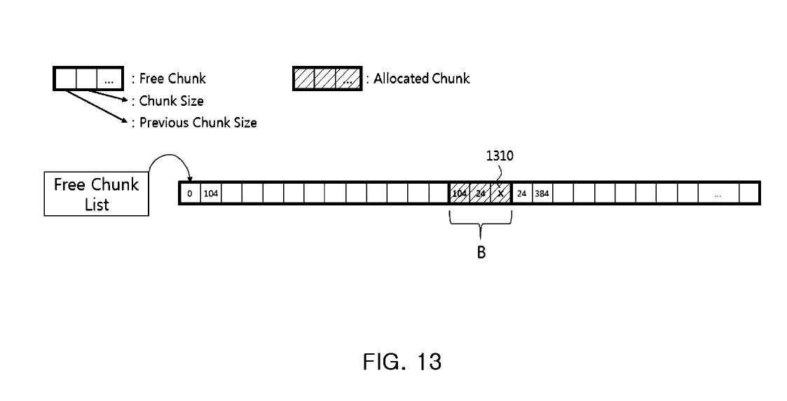

As an example, as illustrated in FIG. 13, when a chunk 1310 including the error cells is present in the free chunk list included in the memory chunk list, the memory management unit 200 configures a block (for example, a block B) including the error cells to an allocated state and generates a new free chunk list by excluding the block including the error cells from the free chunk list (S1040).

Thereafter, the memory management unit 200 allocates a heap memory to any caller (for example, the malloc function) of the program based on the new free chunk list (alternatively, the free chunk list in which the block including the error cells is deleted).

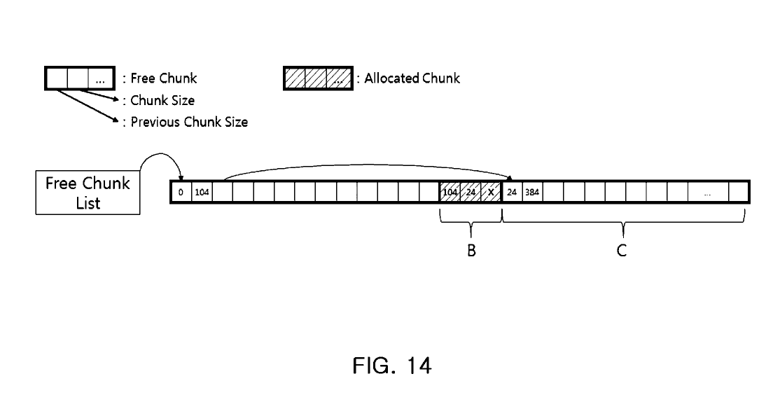

As an example, as illustrated in FIG. 14, the memory management unit 200 allocates a heap memory (for example, a block C) to the malloc function based on the new free chunk list (S1050).

Thereafter, in the case of releasing the heap memory allocated to the caller, the memory management unit 200 registers the chunk corresponding to the heap memory allocated to the caller in the latest free chunk list (alternatively, the new free chunk list) to switch the heap memory allocated to the caller to an available state.

As an example, when the heap memory allocated to the malloc function is released, the memory management unit 200 registers the chunk (for example, the block A in FIG. 12 and the block C in FIG. 14) corresponding to the heap memory allocated to the malloc function in the new free chunk list (S1060).

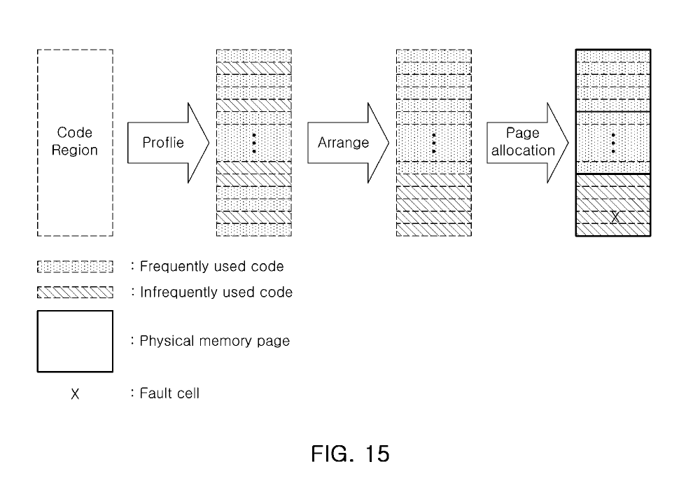

FIG. 15 is a diagram illustrating a code memory management for avoiding the error cells in the main memory. The memory management unit 200 checks a code which is frequently used and which is not frequently used via a profile. Here, whether the code is frequently used or not is determined based on the number of use of the code is over a predetermined number in a predetermined period and/or the last day when the code is used is within the predetermined period.

Further, in the case of code memory, the code memory may be configured by separating the frequently used codes from the codes not used frequently.

Further, the memory management unit 200 may re-arrange the frequently used codes to be continuously arranged separated from the codes not used frequently. This re-arrangement is capable by using a profile. When a code not frequently used is allocated to a page including the error cells, the possibilities to approach the error cells is very low. Thus, the page including the error cells may be used by allocating the page to the code not frequently used.

When approaching the error cells, the memory management unit 200 may read a wrong code, however, it is recoverable according to the following characteristic of the code region. The code region is the value copied to the main memory 100 from a storage(not shown). That is, a copy of the code region exist in the storage. Thus, the memory management unit 200 may re-read the code from the storage and re-allocate it to a page not including the error cells when accessing the error cells.

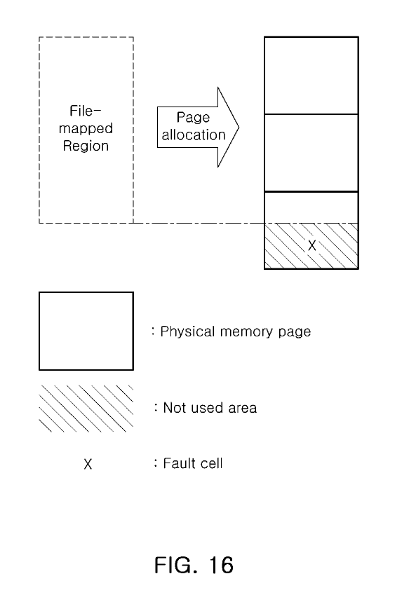

FIG. 16 is a diagram illustrating a file-mapped memory management for avoiding the error cells in the main memory.

The memory management unit 200 allocates the file-mapped memory based on the content of the file described by a user.

Further, the memory management unit 200 manages physical memory by a unit of page. Thus, the memory management unit 200 rounds off the size of file-mapped memory by the unit of page. During the round-off, a bigger size of physical memory is allocated than the size of the file-mapped memory desired by the user. That is, as illustrated in FIG. 16, a space which is not used appears in the last physical memory page of the file-mapped memory. Thus, the memory management unit 200 may allocate the physical memory page including the error cells to this un-used space. As described above, according to the embodiment of the present invention, the software is prevented from accessing a memory region with the errors, thereby preventing a data loss or malfunction which may occur when the processor uses error cells in the main memory.

Further, it is possible to maximize a memory which is allocable to the program and reduce the costs by not using an additional memory as compared with a conventional software solution method by allocating and releasing a stack frame so that a block including the error cells is located between the stack frames in case of a stack region and configuring the block including the error cells to be in an allocated state in case of a heap region memory management.

The aforementioned contents can be corrected and modified by those skilled in the art without departing from the essential characteristics of the present invention. Accordingly, the embodiments disclosed in the present invention are not intended to limit the technical spirit but describe the technical spirit, and the scope of the technical spirit of the present invention is not limited to the embodiments. The protective scope of the present invention should be construed based on the following claims, and all the technical concepts in the equivalent scope thereof should be construed as falling within the scope of the present invention.

### INDUSTRIAL AVAILABILITY

The present invention may be widely used in a dynamic memory device field, a memory field, and the like by preventing a data loss or malfunction from occurring by allocating and releasing a stack frame in a way a block including the error cells to be located between the stack frames in case of a stack region, processing the block including the error cells to be in an allocated state in a heap region memory management data structure in case of a heap region, allocating the pages including error cells to programs not used frequently via profile in case of code memory, and allocating physical memory page including the error cells to unused space of last page in case of file-mapped memory.

1. A stack memory management method for avoiding error cells in a main memory, comprising:
checking, by a memory management unit, information on error cells in the main memory;
checking, by the memory management unit, whether the error cells are located in a space to be allocated to a stack frame of a callee when allocating the stack frame; and
configuring, by the memory management unit, the error cells to be located between a stack frame of a caller and the stack frame of the callee by adjusting a location of the stack frame of the callee to be next to a block including the error cells, when the error cells are located in the space to be allocated to the stack frame of the callee, as the checking result.

2. The stack memory management method of claim 1, wherein in the configuring of the error cells to be located between the stack frame of the caller and the stack frame of the callee, the memory management unit is marked to allocate the stack frame of the callee by reducing a stack pointer corresponding to the last point of the stack frame of the caller by a size corresponding to the space including the error cells and a size corresponding to the stack frame of the callee.

3. The stack memory management method of claim 1, further comprising:
allocating, by the memory management unit, the stack frame of the callee by reducing the stack pointer corresponding to the last point of the stack frame of the caller by a size corresponding to the stack frame of the callee, when the error cells are not located in the space to be allocated to the stack frame of the callee, as the checking result.

4. The stack memory management method of claim 1, further comprising:
moving, by the memory management unit, a stack pointer located at the last point of the stack frame of the callee to an end point of the stack frame of the caller calling the callee when the stack frame allocated to the callee is released.

5. A heap memory management method for avoiding error cells in a main memory, comprising:
checking, by a memory management unit, information on error cells in the main memory;
determining, by the memory management unit, whether a chunk including error cells is present in a plurality of chunks included in a free chunk list;
configuring, by the memory management unit, a block including the error cells in the free chunk list to an allocated state, when the chunk including the error cells is present in the plurality of chunks included in the free chunk list, as the determining result;
generating, by the memory management unit, a new free chunk list by deleting the block including the error cells in the free chunk list after the block including the error cells is marked to be the allocated state; and
allocating, by the memory management unit, a heap memory to a caller of a program based on the new free chunk list.

6. The heap memory management method of claim 5, wherein the free chunk list includes information on a memory space available for dynamic memory allocation in a heap memory region.

7. The heap memory management method of claim 5, further comprising:
switching, by the memory management unit, the heap memory allocated to the caller to an available state by registering a chunk corresponding to the heap memory allocated to the caller in the new free chunk list, when the heap memory allocated to the caller is freed.

8. A stack memory management apparatus for avoiding error cells in a main memory, comprising:
a main memory; and
a memory management unit configured to
check information on error cells in the main memory, and
configure the error cells to be located between a stack frame of a caller and a stack frame of a callee by adjusting a location of the stack frame of the callee to be next to a space including the error cells, when the error cells are located in the space to be allocated to the stack frame of the callee when allocating the stack frame.

9. The stack memory management apparatus of claim 8, wherein the memory management unit is configured to move a stack pointer located at the last point of the stack frame of the callee to an end point of the stack frame of the caller calling the callee, when the stack frame allocated to the callee is released.

10. A heap memory management apparatus for avoiding error cells in a main memory, comprising:
a main memory; and
a memory management unit configured to
check information on error cells in the main memory,
configure a block including the error cells in a free chunk list to an allocated state, when a chunk including the error cells is present in a plurality of chunks included in the free chunk list,
generate a new free chunk list by deleting the block including the error cells from the free chunk list after the block including the error cells is marked to be the allocated state, and
allocate a heap memory to a caller of a program based on the new free chunk list.

11. The heap memory management apparatus of claim 10, wherein the memory management unit is configured to switch the heap memory allocated to the caller to an available state by registering a chunk corresponding to the heap memory allocated to the caller in the new free chunk list, when the heap memory allocated to the caller is released.

12. A code memory management method for avoiding error cells in a main memory, comprising:
checking, by a memory management unit, information on error cells in the main memory;
re-arranging, by the memory management unit, codes according to number of use of each of the codes based on profile result;
allocating, by the memory management unit, one or more pages including the error cells to one or more of the codes not frequently used; and
re-allocating, when approaching the error cells, by the memory management unit, one or more pages including the error cells to the one or more of the codes not frequently used and re-reading a code region from a storage.

13. A file-mapped memory management method for avoiding error cells in a main memory, comprising:
checking, by a memory management unit, information on error cells in the main memory;
checking, by the memory management unit, unused space during rounding off size of file-mapped memory by a unit of page; and
allocating, by the memory management unit, a physical memory page including the error cells to the unused space.
